(19) United States
(12) Patent Application Publication
(10) Pub. No.: US 2013/0038148 A1
(43) Pub. Date: Feb. 14, 2013

(54) HAND-HELD MACHINE TOOL WITH IMPROVED OUTPUT EFFICIENCY

(71) Applicant: Bach Pangho Chen, Claremont, CA (US)

(72) Inventor: Bach Pangho Chen, Claremont, CA (US)

(21) Appl. No.: 13/207,866

(22) Filed: Aug. 11, 2011

(51) Int. Cl. H02K 7/14

(52) U.S. Cl. 310/50

(57) ABSTRACT

A hand-held machine tool with improved output efficiency includes a casing to hold a control circuit connected to a power source and an electric motor which includes a stator, a rotor and an output spindle. The stator has a core and a plurality of stator magnetic poles extended radially. The stator magnetic poles are wound by an exciting winding. The core has an axle hole run through by the output spindle. The rotor has a transmission portion fastened to the output spindle and an induction portion extended from the transmission portion and horizontally corresponding to the stator magnetic poles. The induction portion has a plurality of rotor magnetic poles on an inner rim thereof corresponding to the stator magnetic poles. The rotor magnetic poles and stator magnetic poles are magnetically coupled to induce a magnetic force to drive the output spindle to rotate against the stator in the axle hole.

### FIELD OF THE INVENTION

The present invention relates to a hand-held machine tool with improved output efficiency and particularly to a hand-held machine tool equipped with a motor including rotor magnetic poles provided in a greater number.

### BACKGROUND OF THE INVENTION

Small machine tools (including pneumatic or electric driven) are compact in size, inexpensive and consume less energy, thus are well accepted in the market. They can be made in a wide variety of types, such as emery grinders, drills, pneumatic (or electric) wrenches or the like. Electric machine tool has advantages of offering precise control of driving current of the electric motor through a circuit and control of rotation rate via regulation of the current or frequency.

The primary object of the electric motor is to provide an output force to drive an output spindle which has a distal end coupled with a tool element. The horsepower and torque provided by the electric motor directly affect work performance of the machine tool. The conventional hand-held machine tool, due to considerations of size and actual operation requirements, often employs the electric motor of high rotation rate, then meets designed specifications by adjusting motor output characteristics or selectively adding a transmission gear set.

For instance, U.S. publication No. 2010/0105287 discloses a hand-held machine tool which includes a housing to hold a motor. The motor includes a casing, a stator (6) and a rotor (7). The rotor is held in the stator. The stator surrounds the rotor to form an internal-rotor motor. Due to internal space constraint of the motor the rotor has fewer magnetic poles. According to electromagnetic principle, the motor of fewer magnetic poles generates mechanical output at a high rotation rate but at a lower torque.

To remedy the drawback of the lower torque, output of the motor with the lower speed inner rotor is incorporated with a gear set so that a greater torque is generated through gear transformation via a plurality of gears. A reference of electric motor incorporating with a gear set can be found in R.O.C. publication No. 200932424 entitled “Chargeable electric driving grinding tool”. It provides an electric grinding tool with a casing to hold a chargeable lithium battery pack, a trigger switch and a driving motor. The driving motor drives an operation disk via a planetary reducing gear set which changes the horsepower and torque finally output to the operation disk. Although the horsepower and torque of the output spindle of the electric motor can be changed via the reducing gear set, the driving power transformation process incurs energy loss, and greater loss occurs when more gears are involved. As a result, electric energy utilization efficiency is lower. Moreover, adopted the gear set increases assembly and installation difficulty, production cost is higher, and more internal space of the machine tool casing is occupied. The lifespan of the gears also affects service life of the hand-held machine tool.

Hence there is still room for improvement on the hand-held machine tool, especially on the lower electric utilization efficiency.

### SUMMARY OF THE INVENTION

In view of the conventional hand-held electric machine tool that adopts the principle of reducing speed via gear ratio to change the horsepower or torque between the motor and output end that results in driving power loss during gear set operation and lower electric utilization efficiency, the primary object of the present invention is to provide a hand-held machine tool with improved electric utilization efficiency.

The present invention provides a hand-held machine tool with improved output efficiency. It includes a casing, a control circuit located in the casing to connect to a power source and an electric motor. The control circuit determines amount of electric power sent to the electric motor. The electric motor includes a stator, a rotor and an output spindle. The stator has a core and a plurality of stator magnetic poles extended radially from the core. The stator magnetic poles are wound by an exciting winding connected electrically to the control circuit. The core has an axle hole. The output spindle rotatably runs through the axle hole. The rotor has a transmission portion fastened to the output spindle and an induction portion extended from the transmission portion to horizontally correspond to the stator magnetic poles. The induction portion has a plurality of rotor magnetic poles on an inner rim thereof corresponding to the stator magnetic poles. The rotor magnetic poles and stator magnetic poles are magnetically coupled to induce and generate a magnetic force to drive the output spindle to rotate against the stator in the axle hole.

More specifically, the rotor magnetic poles are provided in a number ranged from 16 to 36. The rotor magnetic poles are respectively made of a magnet. The axle hole holds at least one bearing run through by the output spindle to support steady spinning of the output spindle. The output spindle has a tool fastening end exposed outside the axle hole to fasten to a machining tool, and is coupled with a vane set at one end opposite to the tool fastening end. The induction portion of the rotor is located outside the stator to cover the stator magnetic poles. Hence the inner rim of the induction portion has greater space to hold 16 to 36 rotor magnetic poles. As the rotor has more magnetic poles and based on the principle of N=120 F/P (Rotation rate=120× Frequency/Number of magnetic poles of the motor), the rotation rate of the motor can be reduced. According to law of conversation of energy, lower rotation rate of the motor with a given output power has greater rotating torque on the rotor. Hence the invention provides the electric motor with a higher torque without the gear set. Driving power loss caused by the gear set can be reduced and occupying internal space also decreases.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the hand-held machine tool of the invention.

FIG. 2 is an exploded view of the electric motor of the invention.

FIG. 3 is a sectional view of the electric motor of the invention.

FIG. 4 is another sectional view of the electric motor of the invention.

### DETAILED DESCRIPTION OF THE PREFERRED EMBODIMENT

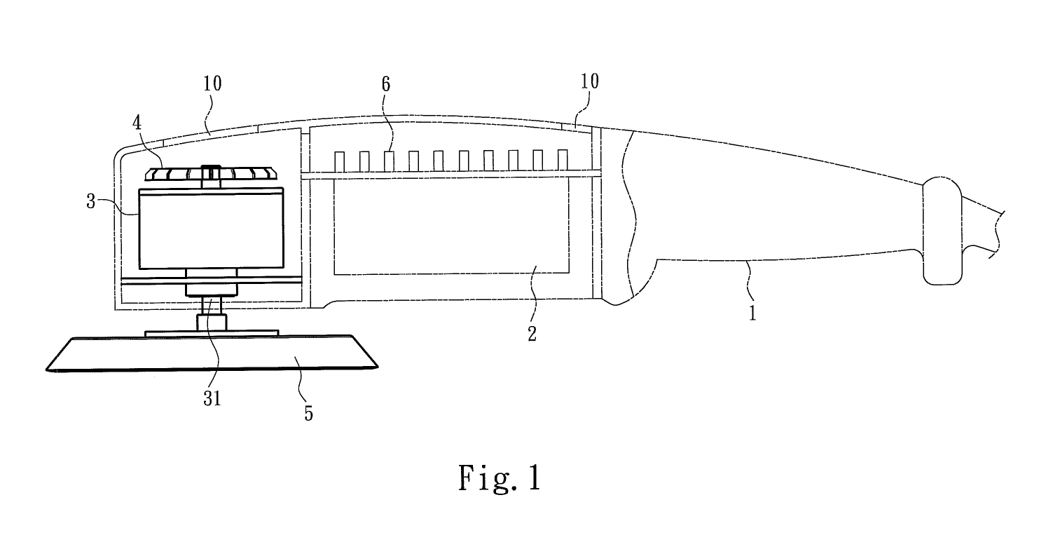

The present invention aims to provide a hand-held machine tool with improved output efficiency. Please referring to FIG. 1, it includes a casing 1 to hold a control circuit 2 connected to a power source (not shown in the drawing) and a DC brushless electric motor 3. The control circuit 2 gets input electric power from the power source and determines the amount of electric power sent to the electric motor 3. The hand-held machine tool has an operation mechanism operable by users. Operation of the operation mechanism determines the amount of electric power driven the electric motor 3 by the control circuit 2. The operation mechanism is a technique known in the art, thus is not shown in the drawings. Similarly, wiring between the control circuit 2 and power source, and the control circuit 2 and electric motor 3 also is a technique known in the art, thus also is not shown in the drawings. The electric motor 3 has an output spindle 31 extended outwards. The output spindle 31 has one end fastened to a machining tool 5 which can be a grinding disk or abrasion collar or other rotational machining tools commonly used. The output spindle 31 is rotated to drive the machining tool 5 to perform function required by the users. The output spindle 31 is coupled with a vane set 4 at one end which also rotates with the rotation of the output spindle 31. The casing 1 has a plurality of ventilation vents 10. The rotation of the vane set 4 drives air to flow in and out via the ventilation vents 10 to dispel heat generated by the electric motor 3 and control circuit 2 during operation. Furthermore, the hand-held machine tool has at least one cooling element 6 held in the casing 1 that is in contact with the control circuit 2 to enhance cooling effect.

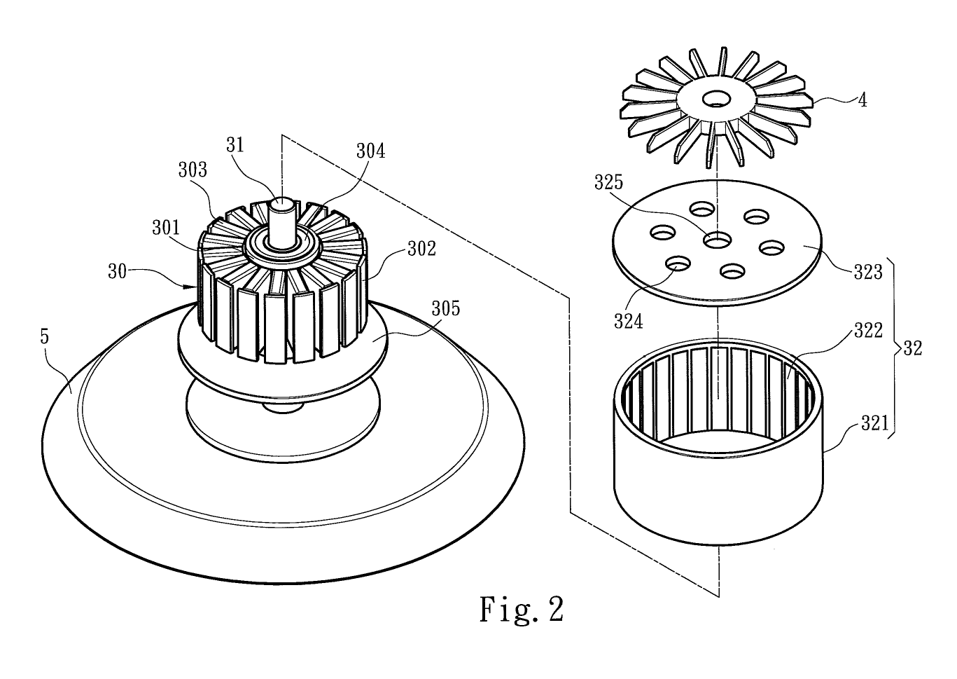

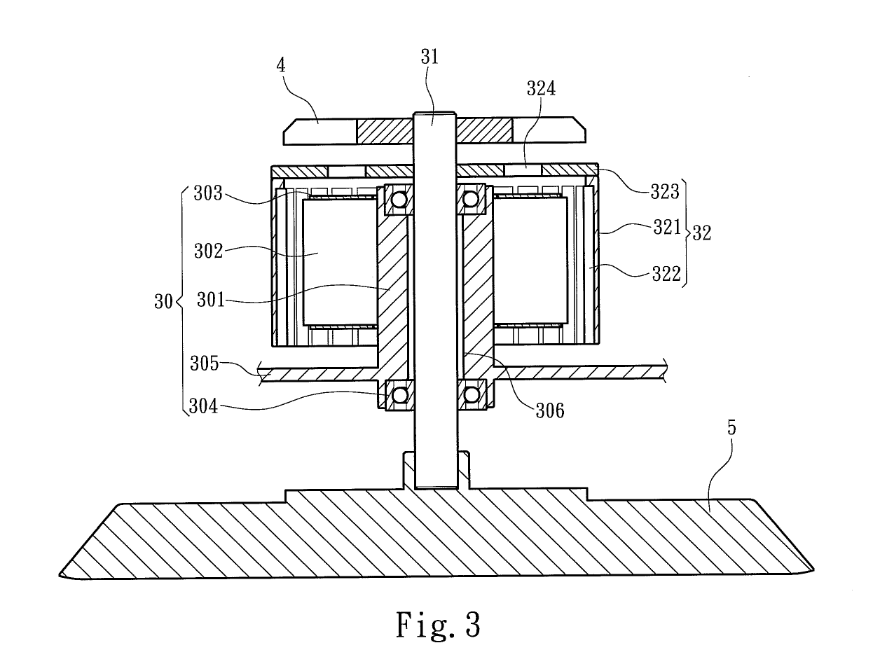

Please referring to FIGS. 2, 3 and 4, the electric motor 3 includes a stator 30 and a rotor 32 fastened to the output spindle 31. The stator 30 includes a core 301 and a plurality of stator magnetic poles 302 extended radially from the core 301. The stator magnetic poles 302 are wound by an exciting winding 303 electrically connected to the control circuit 2. The control circuit 2 provides electric power according to user operation to the exciting winding 303. The core 301 has an axle hole 306 (referring to FIG. 3) run through by the output spindle 31. The axle hole 306 holds at least one bearing 304 run through by the output spindle 31 to form bracing for the output spindle 31. The core 301 has at least one bracket 305 extended to couple with the casing 1 so that the stator 30 is fixedly held in the interior space of the casing 1. The output spindle 31 runs through the axle hole 306 with two ends exposed outside the stator 30. One end of the output spindle 31 is fastened to the machining tool 5, and another end is fastened to the rotor 32. The rotor 32 has an induction portion 321 and a transmission portion 323. The transmission portion 323 includes a ventilation hole 324 and an engaging portion 325 fastened to the output spindle 5. The induction portion 321 is fastened to the transmission portion 323 and is bent and extended downwards so that the induction portion 321 is horizontally corresponding to the stator magnetic poles 302.

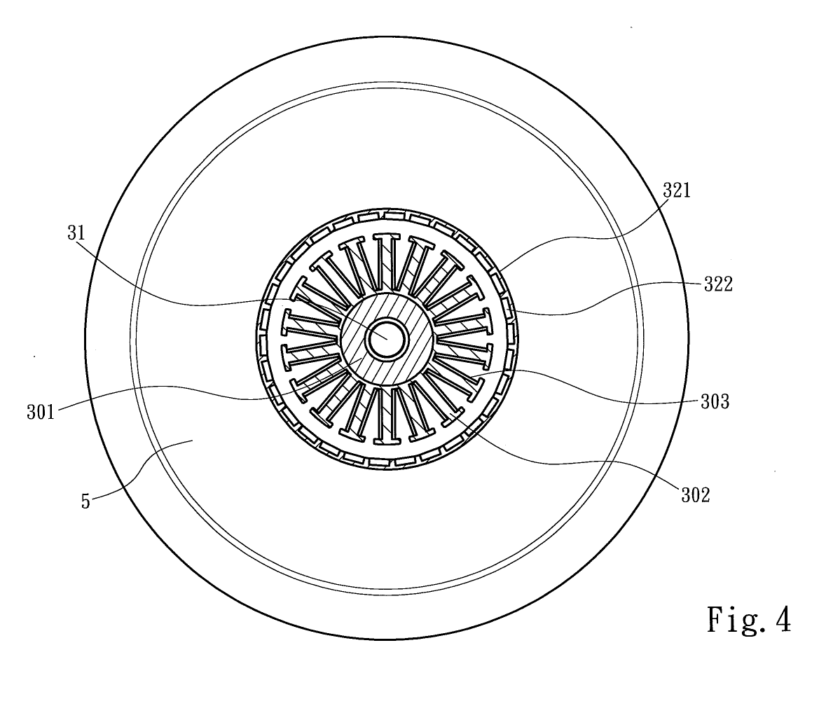

As shown in FIGS. 3 and 4, the stator 30 is run through by the output spindle 31. The transmission portion 323 of the rotor 32 is extended horizontally for a selected length from the output spindle 31, and then is bent downwards to form the induction portion 321. Viewed horizontally, the stator magnetic poles 302 are covered in the induction portion 321 with the inner rim thereof facing the stator magnetic poles 302. The inner rim of the induction portion 321 also has a plurality of rotor magnetic poles 322 corresponding to the stator magnetic poles 302. The rotor magnetic poles 322 can be permanent magnets. The control circuit 2 provides electric power to the exciting winding 303 to magnetize the stator magnetic poles 302. The rotor magnetic poles 322 and the stator magnetic poles 302 are magnetically coupled to induce and generate a magnetic force on the rotor magnetic poles 322 so that the rotor 32 is driven to rotate to further drive the output spindle 31 rotating. The rotation of the output spindle 31 not only drives the machining tool 5 to rotate, but also drives the vane set 4 to generate airflow. The ventilation hole 324 also can aid airflow to provide desired cooling effect for the electric motor 3. As the stator magnetic poles 302 are extended outwards radially from the core 301, and the induction portion 321 of the rotor 32 covers the stator magnetic poles 302 from the outer side, the induction portion 321 has a greater circumference to hold more rotor magnetic poles 322. The present invention sets at least sixteen rotor magnetic poles 322 on the induction portion 321, in practice, 16 to 36 of rotor magnetic poles 322 can be provided, preferably 18 to 30. According to the structure of the invention previously discussed, the number of the rotor magnetic poles 322 is much greater than the internal-rotor motor. Based on equation of N=120 F/P (Rotation rate=120× Frequency/Number of magnetic poles of the motor) and law of conversation of energy, the lower rotation rate of the rotor 32 with a given output power has greater rotating torque on the rotor 32. Furthermore, due to the rotor 32 is located on the outer side of the stator 30, the linear distance between the rotor magnetic poles 322 of the induction portion 321 and the output spindle 31 is longer than that of the conventional inner rotor type motor. According to mechanics equation of T=F×D (Torque=Force×Distance), the greater distance between the rotor magnetic poles 322 and the output spindle 31 in the invention further increases the rotating torque of the rotor 32. With the electric motor 3 of the invention providing the two aforesaid features that can enhance the torque, the hand-held machine tool of the invention can provide a greater torque than the conventional electric tool without the need of adding the reducing gear set. Thus material cost is lower, and extra space occupied by the gear set also can be saved, assembly and installation also are simpler.

While the invention has been described by means of a specific embodiment set forth above, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. A hand-held machine tool providing improved output efficiency, comprising:
a casing; and
an electric motor which is held in the casing and includes a stator, a rotor and an output spindle, the stator including a core and a plurality of stator magnetic poles extended radially from the core, the output spindle rotatably running through the core, the rotor including an induction portion horizontally corresponding to the stator magnetic poles and a transmission portion fastened to the output spindle, the induction portion including a plurality of rotor magnetic poles on an inner rim thereof corresponding to the stator magnetic poles, the rotor magnetic poles magnetically coupling with the stator magnetic poles to induce and generate a magnetic force to drive the output spindle to rotate against the stator;
wherein the rotor magnetic poles are provided in a number ranged from sixteen to thirty six.

2. The hand-held machine tool of claim 1, wherein the core includes an axle hole run through by the output spindle, the axle hole holding at least one bearing to brace the output spindle.

3. The hand-held machine tool of claim 1, wherein the rotor magnetic poles are provided in a number ranged from eighteen to thirty.

4. The hand-held machine tool of claim 1, wherein the output spindle includes a tool fastening end exposed outside the core to fasten to a machining tool.

5. The hand-held machine tool of claim 4, wherein the output spindle is coupled with a vane set at one end opposite to the tool fastening end.

6. The hand-held machine tool of claim 1, wherein the rotor magnetic poles are respectively a magnet.

7. The hand-held machine tool of claim 1, wherein the stator further includes a bracket fastened to the casing to hold the stator in the casing.

8. The hand-held machine tool of claim 1, wherein the stator magnetic poles are wound by an exciting winding, the casing including a control circuit operable by users to provide electric power to the exciting winding.

9. The hand-held machine tool of claim 1 further including at least one cooling element.
